(19) United States
(12) Patent Application Publication
(10) Pub. No.: US 2026/0169768 A1
(43) Pub. Date: Jun. 18, 2026

(54) APPARATUS AND METHODS FOR GENERATION OF A USER INTERFACE FOR TECHNOLOGY INTEGRATION

(71) Applicant: Joshua Oladele OWOLABI, Moultrie, GA (US)

(72) Inventor: Joshua Oladele OWOLABI, Moultrie, GA (US)

(21) Appl. No.: 19/419,354

(22) Filed: Dec. 15, 2025

Related U.S. Application Data
(60) Provisional application No. 63/733,695, filed on Dec. 13, 2024.

(51) Int. Cl. G06F 9/451; G06F 3/0482; G09B 7/06

(52) U.S. Cl. CPC G06F 9/451; G06F 3/0482; G09B 7/06

(57) ABSTRACT

Provided herein is an apparatus and method for generation of a user interface for technology integration, the apparatus including: at least a processor; and a memory, wherein the memory contains instructions configuring the at least a processor to: generate a technology integration user interface; present the technology integration user interface to a user; receive candidate technology data from the user; select a plurality of queries; generate a response interface; present, to the user, the response interface through the user interface; receive the binary responses through the response interface; and determine a set of technology certification scores as a function of the binary responses.

### CROSS REFERENCE TO RELATED APPLICATIONS

This application claims the benefit of priority to U.S. Provisional Application No. 63/733,695, filed on Dec. 13, 2024, and entitled “DIGITISED ASIC FRAMEWORK: AN INNOVATION FOR OPTIMISING TECHNOLOGIES AND INNOVATIONS FOR MEDICAL AND HIGHER EDUCATION,” the entirety of which is incorporated herein by reference.

### FIELD OF THE INVENTION

The present application generally relates to the field of user interfaces. In particular, the present invention is directed to apparatus and methods for generation of a user interface for technology integration.

### BACKGROUND OF THE INVENTION

Educational technologies [EdTech] and innovations have become increasingly integral to other education in general, and especially for medical education and health professional education. This is largely a reflection of general advancements in technologies, innovations and ways of life that have largely been based on technology. It is also a reflection of the transitions from the industrial age to the information age and the emphasis on the use of cutting or bleeding-edge approaches to driving changes and creating solutions which in turn is largely technology-dependent. More specifically, the importance of technologies and innovations in support of medical education, medical education and health professions is high. However, existing attitudes can hinder the introduction of technology into existing fields. Additionally, existing solutions do not provide an easy-to-use and automated user interface that will guide users concerning technology integration.

Accordingly, there remains a need in the art for a technology integration method and interface that improve upon existing technology integration methods. The present disclosure meets this need.

### SUMMARY OF THE DISCLOSURE

In some aspects, the techniques described herein relate to an apparatus for generation of a user interface for technology integration, the apparatus including: at least a processor; and a memory, the memory communicatively connected to the at least a processor, wherein the memory contains instructions configuring the at least a processor to: generate a technology integration user interface; present, through a display device, the technology integration user interface to a user; receive, through the technology integration user interface, candidate technology data from the user; select, as a function of the candidate technology data, a plurality of queries; generate a response interface, wherein: the response interface includes the plurality of queries; and the response interface is configured to receive a binary response for each of the plurality of queries; present, to the user, the response interface through the user interface; receive the binary responses through the response interface; and determine a set of technology certification scores as a function of the binary responses, wherein the set of technology certifications scores include scores for at least four tenets; determine a pass fail state as a function of comparing each of the scores for the at least four tenets to a threshold score value; and display, through the user interface, each of the scores for the at least four tenets and the pass fail state.

In some aspects, the techniques described herein relate to an method for generation of a user interface for technology integration, the method including: generating, using at least a processor, a technology integration user interface; presenting, using the at least a processor and through a display device, the technology integration user interface to a user; receiving, using the at least a processor and through the technology integration user interface, candidate technology data from the user; selecting, using the at least a processor and as a function of the candidate technology data, a plurality of queries; generating, using the at least a processor, a response interface, wherein: the response interface includes the plurality of queries; and the response interface is configured to receive a binary response for each of the plurality of queries; presenting, using the at least a processor, to the user, the response interface through the user interface; receiving, using the at least a processor, the binary responses through the response interface; and determining, using the at least a processor, set of technology certification scores as a function of the binary responses, wherein the set of technology certifications scores include scores for at least four tenets; determining, using the at least a processor, a pass fail state as a function of comparing each of the scores for the at least four tenets to a threshold score value; and displaying, using the at least a processor, through the user interface, each of the scores for the at least four tenets and the pass fail state.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 shows an exemplary embodiment of an apparatus for generation of a user interface for technology integration;

FIG. 2 shows an exemplary user interface;

FIG. 3 shows an exemplary usage flow of software;

FIG. 4 shows an exemplary input interface;

FIG. 5 shows an exemplary response interface;

FIG. 6 shows another exemplary user interface;

FIG. 7 shows an exemplary chatbot interface;

FIG. 8 shows an exemplary embodiment of an ASIC framework;

FIG. 9 shows a table of some key considerations for individuals when using ASIC;

FIG. 10 shows a table of some key considerations for group use when using ASIC

FIG. 11 shows a table of some key considerations for institutional and professional use when using ASIC;

FIG. 12 shows a method for generation of a user interface for technology integration; and

FIG. 13 shows a diagrammatic representation of one embodiment of a computing device in the exemplary form of a computer system.

### DETAILED DESCRIPTION

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a: b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a: b and b: a are inverse and increase and decrease, respectively, over the time period.

### DETAILED DESCRIPTION

Provided herein is an apparatus and method for generation of a user interface for technology integration, the apparatus including: at least a processor; and a memory, the memory communicatively connected to the at least a processor, wherein the memory contains instructions configuring the at least a processor to: generate a technology integration user interface; present, through a display device, the technology integration user interface to a user; receive, through the technology integration user interface, candidate technology data from the user; select, as a function of the candidate technology data, a plurality of queries; generate a response interface, wherein: the response interface includes the plurality of queries; and the response interface is configured to receive a binary response for each of the plurality of queries; present, to the user, the response interface through the user interface; receive the binary responses through the response interface; and determine a set of technology certification scores as a function of the binary responses, wherein the set of technology certifications scores include scores for at least four tenets; determine a pass fail state as a function of comparing each of the scores for the at least four tenets to a threshold score value; and display, through the user interface, each of the scores for the at least four tenets and the pass fail state.

In some aspects, the techniques described herein relate to an method for generation of a user interface for technology integration, the method including: generating, using at least a processor, a technology integration user interface; presenting, using the at least a processor and through a display device, the technology integration user interface to a user; receiving, using the at least a processor and through the technology integration user interface, candidate technology data from the user; selecting, using the at least a processor and as a function of the candidate technology data, a plurality of queries; generating, using the at least a processor, a response interface, wherein: the response interface includes the plurality of queries; and the response interface is configured to receive a binary response for each of the plurality of queries; presenting, using the at least a processor, to the user, the response interface through the user interface; receiving, using the at least a processor, the binary responses through the response interface; and determining, using the at least a processor, set of technology certification scores as a function of the binary responses, wherein the set of technology certifications scores include scores for at least four tenets; determining, using the at least a processor, a pass fail state as a function of comparing each of the scores for the at least four tenets to a threshold score value; and displaying, using the at least a processor, through the user interface, each of the scores for the at least four tenets and the pass fail state.

Educational technologies [EdTech] and innovations have become increasingly integral to other education in general, and especially for medical education and health professional education. This is largely a reflection of general advancements in technologies, innovations and ways of life that have largely been based on technology. It is also a reflection of the transitions from the industrial age to the information age and the emphasis on the use of cutting or bleeding-edge approaches to driving changes and creating solutions which in turn is largely technology-dependent. More specifically, the importance of technologies and innovations in support of medical education, medical education and health professions is high. Increasingly, the tech-driven, the culture of technology has significantly permeated medical, professional and higher education. In fact, imbuing a tech culture into medical training and practice has arguably become a major aspect of emphasis toward training workers and professionals for the current places of work and is very important to meet the needs of the future demands in workplaces. Graduates and professionals without technological skills would not only have lacked vital skills but would also be alien to the emerging culture of work. People's acceptance or aversions to technology could be complicated but not impossible to explain. For example, the Technology Acceptance Model (TAM) posits that users are motivated to use technology by three factors namely: perceived usefulness, perceived ease of use, and attitude toward use.

There is evidence that technology is increasingly becoming integral to medical education and health service delivery. This is true at discipline level, such as in Anatomy and for the medical education in general. There were significant successes recorded with the use of EdTech and innovation to support and sustain medical education and healthcare delivery during the COVID-19 pandemic.

Having established the place of innovation and EdTech in today's educational ecosystem, it is important to further highlight the place of technologies and innovations and their continuous deployment for educational purposes. One thing is clear, technology influences not just the use of technologies for educational activities but also the established methods, traditional practices, and consequently, the culture of education and practice. In other words, technology used for educational purposes could influence the knowledge, skills and attitudes of not just the learners and trainees but also the educators and trainers as well. This last statement may explain why the use of technology would require critical considerations, references to empirical evidence and adherence to guiding principles and relevant theories. Poor consideration for standard practices, pedagogical principles and relevant learning theories have resulted in observable heterogeneities in methods of edtech use and the impacts they produce on learners. This needs to be addressed. In line with the present realities, a framework for technology integration within educational setting has been established.

One may hypothesize that heterogeneity in types and uses of innovations and technologies would limit their validity and reliability to achieve educational outcomes or competencies with optimal outcomes except they are used based on guiding principles that are premised on sound educational theories as well as empirical; the evidence is used to form the basis of judgement, and strategies for use and their pedagogical approaches. Furthermore, to optimize the use of an innovation for Edtech to support higher education or MedEd there are three key areas of considerations which include: Curriculum, Pedagogy, and assessment.

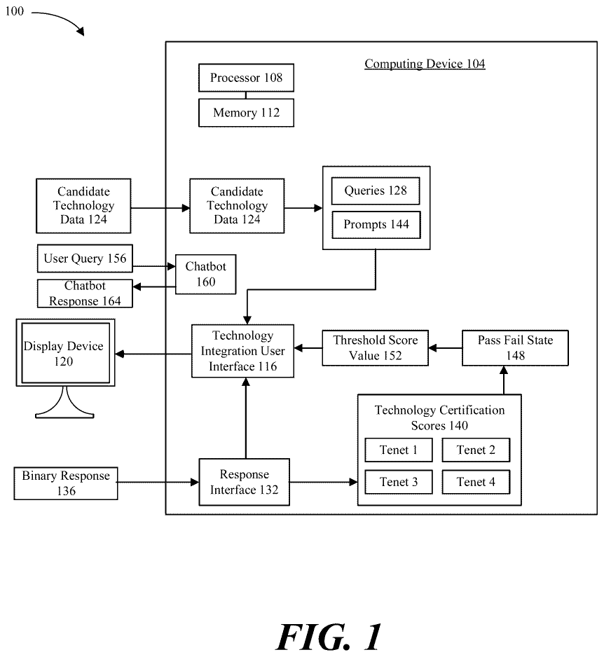

Referring now to FIG. 1, an exemplary embodiment of an apparatus 100 for generation of a user interface for technology integration is shown. Apparatus 100 may include a computing device 104 The apparatus for generation of a user interface for technology integration comprises at least a processor 108 and a memory 112, the memory communicatively connected to the at least a processor 108. The memory 112 may include instructions, wherein the instructions may configure the at least a processor 108 to perform one or more actions as described throughout this disclosure. In some embodiments, the at least a processor 108 may include circuitry.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors.

With continued reference to FIG. 1, processor 108 may be designed and/or configured to perform any method, method step, or sequence of method steps in any embodiment described in this disclosure, in any order and with any degree of repetition. For instance, processor 108 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 108 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, memory 112 may include instructions configuring processor 108 to generate a technology integration user interface 116. A “user interface,” for the purposes of this disclosure, is an interface through which a user is able to interface with a computer system or software.

With continued reference to FIG. 1, in some embodiments, a user interface may include a graphical user interface (GUI). A “graphical user interface,” for the purposes of this disclosure, is a user interface wherein a user is able to interface with a computer using one or more graphical elements. In some embodiments, graphical elements may include a menu. A menu may be a graphical element that presents a plurality of selectable elements to a user so that they may select one of the selectable elements. For example, selectable elements may include “menu,” “settings,” “profile,” and the like; a user may select, e.g., “profile” in order to access a profile. Menus may include radial menu. A radial menu may be a menu wherein the selectable elements are presented radial around a point in a GUI. For example, in some embodiments, radial menus may be responsive to user cursor locations, such that the radial menu may be presented radially around the user's cursor (or location of the user's cursor) when the user performs a certain action. In some embodiments, menus may include drop-down menus. As a non-limiting example, a drop down menu may include a button, wherein, when the user interacts with or otherwise hovers over the button, a menu drops down below the button. In some embodiments, menus may include horizontal menus. In horizontal menus, selectable options may be presented along a horizontal line. In some embodiments, menus may include vertical menus. In vertical menus, selectable options may be presented along a vertical line.

With continued reference to FIG. 1, in some embodiments, GUI may include one or more buttons. A “button,” for the purposes of this disclosure in the context of a GUI, is an interactable element in a GUI that responds to a user clicking or tapping on it. Buttons may cause actions to occur when interacted with; for example, in some embodiments, this may be accomplished using event handlers, event watchers, or the like.

With continued reference to FIG. 1, in some embodiments, GUI may include one or more icons. An “icon,” for the purposes of this disclosure in the context of a GUI, is a symbolic image that represents a program, selectable option, or action within a GUI. For example icons may include logos for the relevant product. In some embodiments, icons may be pictorial. In some embodiments, icons may function as buttons, wherein a user clicking or tapping on it may cause an action to occur.

With continued reference to FIG. 1, in some embodiments, GUI may be user configurable. In some embodiments, users may be allowed to rearrange or reconfigure any of the user interface elements described above. For example, user's may select locations for icons, convert horizontal menus to vertical menus, move elements of the GUI to other locations, and the like. In some embodiments, GUI may be responsive to display or window sizes. For example, the size and/or location of elements of GUI may be recorded as percentages, rather than absolute values. The size and/or position of elements of GUI may then be automatically resized and/or reconfigured when the user's window, screen size, or screen orientation changes.

With continued reference to FIG. 1, memory 112 may include instructions configuring processor 108 to present, through a display device 120, the technology integration user interface 116 to a user. A “display device,” for the purposes of this disclosure, is an electronic device that is capable of displaying visual information to a user. In some embodiments, display device may include a screen, such as an LED, LCD, OLED, plasma, CRT, QLED, AMOLED, e-ink display, or the like. Display device 120 may be configured to display technology integration user interface 116 using a screen such as those described above. Display device 120 may include a monitor, TV, tablet, smartphone, e-reader, digital notepad, or the like.

With continued reference to FIG. 1, memory 112 may include instructions configuring processor 108 to receive, through technology integration user interface 116, candidate technology data 124 from a user. “Candidate technology data,” for the purposes of this disclosure, is data concerning a technology that a user wishes to integrate into existing processes of procedures. Candidate technology data 124 may include, as non-limiting examples, a tool name, brand name, product name, cost, expected benefits, reasons for use, and the like. In some embodiments, candidate technology data 124 may include textual data. Textual data may include one or more tokens or strings. In some embodiments, textual data may include natural language data. In some embodiments, candidate technology data 124 may include sentences, words, tokens, or the like. In some embodiments, candidate technology data 124 may be received through a text box interface. As a non-limiting example, a user may type text into the text box (e.g., in an unstructured member) and then submit the text as candidate technology data 124.

With continued reference to FIG. 1, memory 112 may include instructions configuring processor 108 to select, as a function of candidate technology data 124, a plurality of queries 128. A “query,” for the purposes of this disclosure is a string of words that solicits a response from a user. As non-limiting examples, query may include “Use of technology/innovation is indicated in curriculum/syllabus i.e. there is specified time/period/duration for use” or “the technology or innovation is used to achieve stated learning objectives i.e. there is an objective statement that aligns with EdTech use.”

With continued reference to FIG. 1, memory 112 may include instructions configuring processor 108 to generate a response interface 132. A “response interface,” for the purposes of this disclosure is a user interface configured to receive responses from at least a user. Response interface 132 may include, as a non-limiting example, a plurality of text boxes, wherein the plurality of text boxes are configured to receive responses from a user. Response interface 132 may be configured to receive a binary response 136 one or more of the plurality of queries 128 . . . . Response interface 132 may be configured to receive a binary response 136 for each of the plurality of queries 128. For the purposes of this disclosure, “binary response” is a response that has two possible values. As a non-limiting example, binary response may include a response of either a “yes” or a “no.” As a non-limiting example, binary response may include a response of either a “Y” or an “N.” As a non-limiting example, binary response may include a response of either a “1” or a “0” As a non-limiting example, binary response may include a response of either a “pass” or a “fail.” As a non-limiting example, binary response may include a response of either a “sufficient” or an “insufficient.” As a non-limiting example, binary response may include a response of either a “satisfied” or a “not satisfied.” As a non-limiting example, binary response may be received through a checkbox interface, drop down menu interface, text-entry interface, and the like.

With continued reference to FIG. 1, response interface 132 may include plurality of queries 128. For example, response interface 132 may be configured to present plurality of queries 128 to users. In some embodiments, response interface 132 may include a binary response element. Binary response element may include an element of a user interface (e.g., response interface 132) which a user can use to input a binary response 136. Binary response element may include, as non-limiting examples, a checkbox interface, drop down menu interface, text-entry interface, and the like. In some embodiments, binary response element may be located adjacent to, next to, or proximally to a query of plurality of queries 128. For example, in some embodiments, a binary response element may be located next to each query of plurality of queries 128. For example, in some embodiments, a binary response element may be located below each query of plurality of queries 128.

With continued reference to FIG. 1, in some embodiments, plurality of queries 128 may include at least three queries for each of the four tenants. In some embodiments, plurality of queries 128 may include at least five queries for each of the four tenants. In some embodiments, the at least three queries for each of the four tenants may include a query directed to each of curriculum, pedagogy, and/or assessment. For example, ASIC applications to curriculum, pedagogy, and/or assessment (CPA) are further described below in Table 1.

TABLE 1

| CPA | |
|---|---|
| Domains | ASIC Applications |
| a | This considers the appropriateness of |
| Curriculum | an EdTech/innovation to accomplish learning |
| | outcomes and ultimately program competences |
| | based program design and specific indicative |
| | content in the curriculum. |
| b | This considers the educational value of |
| Pedagogy | the EdTech/innovation based on the applicable |
| | learning theories and pedagogical principles. It |
| | considers whether an EdTech/innovation can adequately |
| | help to achieve the objectives or outcomes |
| | of learning sessions in one or more of the |
| | cognitive, psychomotor and affected domains. |
| c | This considers whether the assessment exercises |
| Assessment | based on the use of an EdTech or innovation could |
| | meet assessment validity and reliability |
| | criteria in alignment with competences that |
| | are required to be acquired ultimately. |

With continued reference to FIG. 1, selecting, as a function of candidate technology data 124, plurality of queries 128 may include presenting a pre-selected plurality of queries 128. For example, the pre-selected queries may be manually set such that they appear the same for every user. In some embodiments, selecting, as a function of candidate technology data 124, plurality of queries 128 may include selecting plurality of queries 128 as a function of a technology type as indicated by 124. In some embodiments, as a non-limiting example, if technology type is “e-learning,” a certain set of plurality of queries 128 may be selected. In some embodiments, as a non-limiting example, if technology type is “grading,” a certain set of plurality of queries 128 may be selected. In some embodiments, plurality of queries 128 for each technology type may be manually set.

With continued reference to FIG. 1, memory 112 may include instructions configuring processor 108 to present, to the user, response interface 132 through the technology integration user interface 116. For example, response interface 132 may be displayed as a window within technology integration user interface 116.

With continued reference to FIG. 1, memory 112 may include instructions configuring processor 108 to receive binary response 136 through response interface 132. As non-limiting examples, binary response 136 may be received through response interface 132 using a checkbox interface, drop down menu interface, text-entry interface, and the like. As a non-limiting example, binary response 136 may be received through response interface 132 using a binary response element.

With continued reference to FIG. 1, memory 112 may include instructions configuring processor 108 to determine a set of technology certification scores 140 as a function of binary responses 136. In some embodiments, determining technology certification scores 140 for the at least four tenets, includes assigning a binary value as a function of the binary response 136 to each of the plurality of queries 128. As a non-limiting example, if binary response 136 is positive, a binary value of “1” may be assigned. As a non-limiting example, if binary response 136 is positive, a binary value of “1” may be assigned. Some embodiments, determining a technology certification score for each tenant may include averaging the binary values for that tenant of the at least four tenants. As a non-limiting example, if there are three queries for a tenant, and the binary values for those queries are “0,” “1,” and “1,” then those may be averaged together and a technology certification score for that tenant may be assigned of 2/3 or 0.6667. In some embodiments, technology certifications score may be a percentage. For example, a raw value of ⅓ or 0.3334 may be converted to or displayed as, e.g., 33%.

With continued reference to FIG. 1, in some embodiments, the at least four tenants may include adaptation. In some embodiments, the at least four tenants may include standardization. In some embodiments, the at least four tenants may include integration. In some embodiments, the at least four tenants may include compliance. In some embodiments, the at least four tenants may include adaptation, standardization, integration, and compliance. An exemplary embodiment of an interpretation of the tenants of adaptation, standardization, integration, and compliance is shown below in Table 2.

TABLE 2

| Adaptation | Standardization |
|---|---|
| Adaptation implies that | Standardization involves |
| innovations and educational | determining clearly the purpose |
| technologies or EdTech should be | that innovations and technologies |
| suitably adapted to the learning | serve, the objectives they meet; and |
| ecosystem, program design and | supporting their uses with evidence |
| institutional system, for optimal | for best and standard practices. It |
| performance and best outcomes. | also involves the use of innovations |
| | and EdTech in alignment with |
| | sound educational and learning |
| | principles. |
| Integration | Compliance |
| Integration involves creating | Compliance emphasizes |
| a place for the use of educational | alignment with institutional policies, |
| innovations and technology within | regulations and practices as well as |
| the immediate teaching or training | relevant regulatory requirements [if |
| ecosystem; and aligning its use | applicable]. Evidence of compliance |
| with other components of the | with institutional standards, program |
| educational system for optimal | requirements and regulations of |
| performance. Key considerations | relevant bodies should be addressed. |
| include system thinking and | |
| synergy. | |

TOTAL SCORE = ASIC VALUE

With continued reference to FIG. 1, selecting the plurality of queries 128 may include selecting, for one or more of plurality of queries 128, one or more prompts 144. One or more prompts 144 may include text configured to provide guidance to the user on answering the plurality of queries 128. As a non-limiting example, one or more prompts 144 may include factors for a user to consider. As a non-limiting example, one or more prompts 144 may include brainstorming ideas for a user.

With continued reference to FIG. 1, set of technology certification scores 140 and the calculation of a pass fail state 148 is further described in Table 3.

TABLE 3

| | | Good | Very Good | Excellent | Outstanding | General |
|---|---|---|---|---|---|---|
| | Poor <60 | 61-70 | 71-80 | 81-90 | 91-100 | comment |
| Adaptation | Does not | Partially | Sufficiently | Sufficiently | Sufficiently | A less than |
| | sufficiently | satisfies at | satisfies at | satisfied at | satisfies | 2/3 score |
| | satisfy at | least 1 | least 1 | least 2 | 3 or more | under |
| | least 1 | adaptation- | adaptation- | adaptation- | adaptation- | Adaptation |
| | adaptation- | related | related | related | related | requires |
| | related | component of | component of | components of | components of | consideration |
| | component of | combined CPA | combined CPA | combined CPA | combined CPA | to sufficiently |
| | combined CPA | requirements | requirements | requirements | requirements | meet the >2/3 |
| | requirements | | | | | requirement. |
| Standardization | Does not | Partially | Sufficiently | Sufficiently | Sufficiently | A less than |
| | sufficiently | satisfies at | satisfies at | satisfies at | satisfies | 2/3 score |
| | satisfy at | least 1 | least 1 | least 2 | 3 or more | under |
| | least 1 | standardization - | standardization - | standardization - | standardization- | Standardization |
| | standardization - | related - | related - | related - | related | requires |
| | related - | component of | component of | components of | components of | consideration |
| | component of | combined CPA | combined CPA | combined CPA | combined CPA | to sufficiently |
| | combined CPA | requirements | requirements | requirements | requirements | meet the >2/3 |
| | requirements | | | | | requirement. |
| Integration | Does not | Partially | Sufficiently | Sufficiently | Sufficiently | A less than |
| | sufficiently | satisfies at | satisfies at | satisfies at | satisfies | 2/3 score |
| | satisfy at | least 1 | least 1 | least 2 | 3 or more | under |
| | least 1 | standardization - | standardization - | standardization - | standardization- | Integration |
| | standardization - | related - | related - | related - | related | requires |
| | related - | component of | component of | components of | components of | consideration |
| | component of | combined CPA | combined CPA | combined CPA | combined CPA | to sufficiently |
| | combined CPA | requirements | requirements | requirements | requirements | meet the >2/3 |
| | requirements | | | | | requirement. |
| Compliance | Does not | Partially | Sufficiently | Sufficiently | Sufficiently | A less than |
| | sufficiently | satisfies at | satisfies at | satisfies at | satisfies | 2/3 score |
| | satisfy at | least 1 | least 1 | least 2 | 3 or more | under |
| | least 1 | standardization - | standardization - | standardization - | standardization- | Compliance |
| | standardization - | related - | related - | related - | related | requires |
| | related - | component of | component of | components of | components of | consideration |
| | component of | combined CPA | combined CPA | combined CPA | combined CPA | to sufficiently |
| | combined CPA | requirements | requirements | requirements | requirements | meet the >2/3 |
| | requirements | | | | | requirement. |
| Total | Consider | Consider | Consider | Consolidate | Sustain ASIC | ASIC |
| | ALL ASIC | ALL ASIC | ASIC tenets | ASIC tenets | tenets values | |
| | tenets to | tenets to | with low ASIC | values by | and translate | |
| | meet minimum | improve on | values to | improving | value to the | |
| | requirements. | EdTech/ | improve | performance | actual context | |
| | | innovations | on EdTech/ | in concerned | of use and | |
| | | performance | innovations' | categories to | practice for | |
| | | requirements. | performance | fully optimize | optimal EdTech | |
| | | | requirements. | EdTech | innovations' | |
| | | | | innovations | performance. | |
| | | | | performance. | | |

With continued reference to FIG. 1, memory 112 may include instructions configuring processor 108 to determine a pass fail state 148. In an embodiments, determining pass fail state 148 may include comparing each of the set of technology certification scores 140 to a threshold score value 152. Threshold score value 152 may be used to determine pass fail state 148. For example, a score of lower than threshold score value 152 may be assigned to a fail state. While a score of higher than or equal to threshold score value 152 may be assigned a pass state.

With continued reference to FIG. 1, memory 112 may include instructions configuring processor 108 to display, through technology integration user interface 116 the set of technology certification scores 140 for each of the at least four tenants. In some embodiments, memory 112 may include instructions configuring processor 108 to display, through technology integration user interface 116 the pass fail state 148.

With continued reference to FIG. 1, memory 112 may include instructions configuring processor 108 to receive, through the user interface, a user query 156. A user query 156 may include a question from a user; as non-limiting examples, a question about the ASIC certification or the software interface. For example, user may ask “what is the meaning of “A” in ASIC?” or “How do I input my response for query 3?” user query 156 may include a string of one or more words or tokens. User query 156 may be received through textual input, voice input and/or transcription. In some embodiments, the user query may include at least a string of natural language text related to technology integration. For example, “how to I integrate this e-learning program into my course?”

With continued reference to FIG. 1, user query 156 may be received by a chatbot 160. A “chatbot,” for the purposes of this disclosure, is a program that is configured to receive natural language queries and generate natural language responses as a function of those natural language queries. In some embodiments, chatbot 160 may use natural language processing techniques. Natural language processing may include converting human language into structured representations that computers can analyze. It may begin with text preprocessing, in which language is cleaned and standardized through steps such as tokenization, lemmatization, and the removal of noise. Statistical or machine learning models can then identify patterns in the text, often relying on large corpora to learn how words relate to one another. Other methods include rule-based systems and traditional algorithms that depend on hand-crafted linguistic rules. Yet other approaches may use neural networks, particularly transformer-based models, which may learn contextual relationships between words by training on massive datasets. These models may encode language into numerical vectors that capture meaning and context, enabling tasks such as translation, summarization, sentiment analysis, and question answering. Finally, the system can generate an output by decoding these learned representations back into human-readable language, guided, e.g., by probabilities learned during training.

With continued reference to FIG. 1, chatbot 160 may include a technology integration large language model. A “large language model,” or “LLM,” as used herein, is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, novels, blog posts, articles, emails, unstructured data, electronic records, and the like. In some embodiments, training sets may include a variety of subject matters, such as, as nonlimiting examples, academic report documents, entity documents, business documents, inventory documentation, emails, user communications, advertising documents, newspaper articles, and the like. In some embodiments, training sets of an LLM may include information from one or more public or private databases. As a non-limiting example, training sets may include databases associated with an entity. In some embodiments, training sets may include portions of documents associated with the electronic records correlated to examples of outputs. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

With continued reference to FIG. 1, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. For example, LLM may be specifically trained on the ASIC framework as described throughout this disclosure. As a non-limiting example, an LLM may be generally trained on a general training set, then specifically trained on a specific training set. In an embodiment, specific training of an LLM may be performed using a supervised machine learning process. In some embodiments, generally training an LLM may be performed using an unsupervised machine learning process. As a non-limiting example, specific training set may include information from a database. As a non-limiting example, specific training set may include text related to the users such as user specific data for electronic records correlated to examples of outputs. In an embodiment, training one or more machine learning models may include setting the parameters of the one or more models (weights and biases) either randomly or using a pretrained model. Generally training one or more machine learning models on a large corpus of text data can provide a starting point for fine-tuning on a specific task. A model such as an LLM may learn by adjusting its parameters during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

With continued reference to FIG. 1, in some embodiments an LLM may include and/or be produced using Generative Pretrained Transformer (GPT), GPT-2, GPT-3, GPT-4, and the like. GPT, GPT-2, GPT-3, GPT-3.5, and GPT-4 are products of Open AI Inc., of San Francisco, CA. An LLM may include a text prediction based algorithm configured to receive an article and apply a probability distribution to the words already typed in a sentence to work out the most likely word to come next in augmented articles. For example, if some words that have already been typed are “Nice to meet,” then it may be highly likely that the word “you” will come next. An LLM may output such predictions by ranking words by likelihood or a prompt parameter. For the example given above, an LLM may score “you” as the most likely, “your” as the next most likely, “his” or “her” next, and the like. An LLM may include an encoder component and a decoder component.

Still referring to FIG. 1, an LLM may include a transformer architecture. In some embodiments, encoder component of an LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 1, an LLM and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

With continued reference to FIG. 1, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 1, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

With continued reference to FIG. 1, multi-headed attention in encoder may apply a specific attention mechanism called self-attention. Self-attention allows models such as an LLM or components thereof to associate each word in the input, to other words. As a non-limiting example, an LLM may learn to associate the word “you,” with “how” and “are.” It's also possible that an LLM learns that words structured in this pattern are typically a question and to respond appropriately. In some embodiments, to achieve self-attention, input may be fed into three distinct fully connected neural network layers to create query, key, and value vectors. A query vector may include an entity's learned representation for comparison to determine attention score. A key vector may include an entity's learned representation for determining the entity's relevance and attention weight. A value vector may include data used to generate output representations. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 1, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 1, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Continuing to refer to FIG. 1, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With further reference to FIG. 1, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 1, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

Still referring to FIG. 1, second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

With continued reference to FIG. 1, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

Still referring to FIG. 1, decoder may take this output and add it to the decoder inputs. Decoder may continue decoding until a token is predicted. Decoder may stop decoding once it predicts an end token.

Continuing to refer to FIG. 1, in some embodiment, decoder may be stacked N layers high, with each layer taking in inputs from the encoder and layers before it. Stacking layers may allow an LLM to learn to extract and focus on different combinations of attention from its attention heads.

With continued reference to FIG. 1, an LLM may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device. User device may be any computing device that is used by a user. As non-limiting examples, user device may include desktops, laptops, smartphones, tablets, and the like. In some embodiments, input may include any set of data associated with candidate technology data 124.

With continued reference to FIG. 1, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like.

With continued reference to FIG. 1, memory 112 may include instructions configuring processor 108 to generate using chatbot 160 and/or technology integration LLM, a chatbot response 164 as function of user query 156. Chatbot response 164 may be presented to a user in technology integration user interface 116. Chatbot response 164 may be displayed on display device 120.

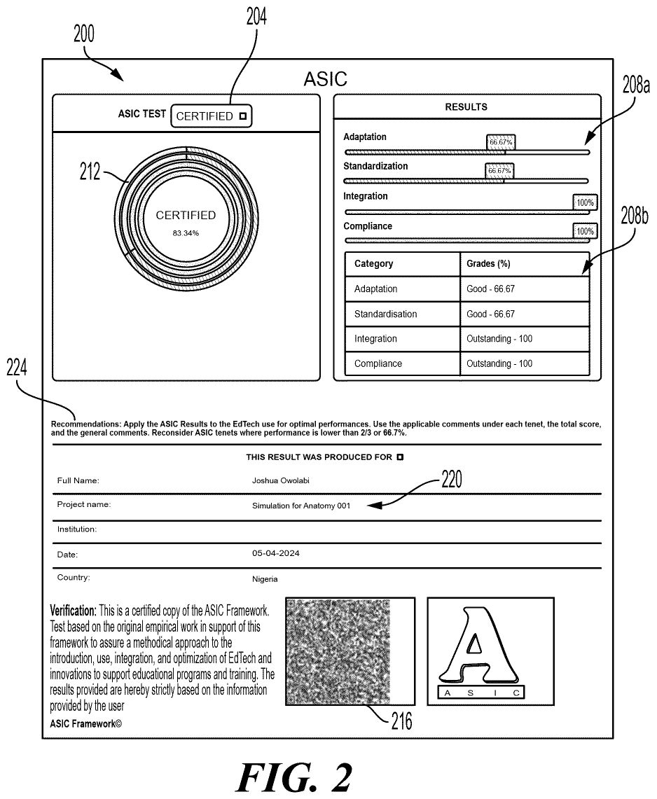

Referring now to FIG. 2, an exemplary user interface 200 is shown. In some embodiments, exemplary user interface 200 may include a certification. For example, exemplary user interface 200 may be configured to certify a user regarding technology integration. In some embodiments, this may include ASIC certification.

With continued reference to FIG. 2, exemplary user interface 200 may include a pass fail state 204. Pass fail state 204 may show whether a user pass or failed the certification. In some embodiments, this may include displaying “pass” or “fail.” In some embodiments, this may include displaying “certified” or “uncertified.” In some embodiments, this may include displaying a picture, pictogram, graphic, or emoji, such as, as a non-limiting example, a check mark for “pass” and an “x” mark for “fail.”

With continued reference to FIG. 2, exemplary user interface 200 may include a display of technology certification scores 208a and 208b. In some embodiments, technology certification scores 208a may include the technology certification scores displayed on a linear meter. For example, the linear meter may include a bar that shows the score out of a max score. In some embodiments, technology certification scores 208b may include a table display, wherein the technology certifications scores 208b are displayed in a table.

With continued reference to FIG. 2, exemplary user interface 200 may include a circumferential meter 212. Circumferential meter 212 may be configured to display a circumferential segment for each of the scores for the at least four tenets. The circumferential segment may span a segment of a circumference of a circle, wherein the length of the circumferential segment is determined by a ratio of each of the scores of the at least four tenets to a maximum value. For example, a ratio of 2/3 could be represented using a circumferential segment spanning 2/3 of the circumference of a circle.

With continued reference to FIG. 2, circumferential meter 212 may include a first circumferential segment associated with a first tenant. As a non-limiting example, first tenant may include adaptation. In some embodiments, circumferential meter 212 may include a second circumferential segment associated with a second tenant. As a non-limiting example, second tenant may include Standardization. In some embodiments, circumferential meter 212 may include a third circumferential segment associated with a third tenant. As a non-limiting example, third tenant may include Integration. In some embodiments, circumferential meter 212 may include a fourth circumferential segment associated with a fourth tenant. As a non-limiting example, fourth tenant may include Compliance.

With continued reference to FIG. 2, in some embodiments, circumferential meter 212 may include concentric circumferential segments. For example, in some embodiments, the first circumferential segment, the second circumferential segment, the third circumferential segment, and the fourth circumferential segment may be concentrically located on the circumferential meter. In some embodiments, first circumferential segment may be located closest to the interior, then second circumferential segment, then third circumferential segment, then, closest to the exterior, fourth circumferential segment. In some embodiments, fourth circumferential segment may be located closest to the interior, then third circumferential segment, then second circumferential segment, then, closest to the exterior, first circumferential segment. In some embodiments, the different circumferential segments may be color coded. In some embodiments, each may be assigned its own color. In another embodiments, circumferential segments associated with passing scores may be assigned a first color, while circumferential segments associated with failing scores may be assigned a second color.

With continued reference to FIG. 2, exemplary user interface 200 may include a digital code 216. Digital code 216 may include a barcode. Digital code 216 may include a QR code. Digital code 216 may include a data matrix. Digital code 216 may include an Aztec code. In some embodiments, digital code 216 may be displayed to a user through a user interface. In some embodiments, a processor (e.g., processor 108) may be configured to generate the digital code 216 for each test result. In some embodiments, digital code 216 may encode the test results (e.g., technology certification scores, pass fail state, feedback, and/or the like). In some embodiments, digital code 216 may encode a URL. URL may be located on the web and may include the test results for the user. This digital code digital code 216 represents a technical improvement as it may allow for non-paying customers to access test results using digital code 216 without needing user's login information. This alleviates security concerns associated with sharing login information and is easier. Additionally, this may allow a user to establish to a third party that they have received certification, without the third party needing a subscription or account. This makes it easier for users to show others that they are certified.

With continued reference to FIG. 2, exemplary user interface 200 may include feedback 220. Feedback 220 may include advice or instructions to a user to improve their score or obtain a passing score. In some embodiments, certain scores may be assigned to pieces of feedback. A processor may automatically retrieve the associated pieces of feedback and display them to the user.

With continued reference to FIG. 2, exemplary user interface 200 may include user data 224. In some embodiments, user data 224 may include one or more pieces of candidate technology data 124. User data 224 may include, as non-limiting examples, names, project names, institution names, dates, countries, and the like.

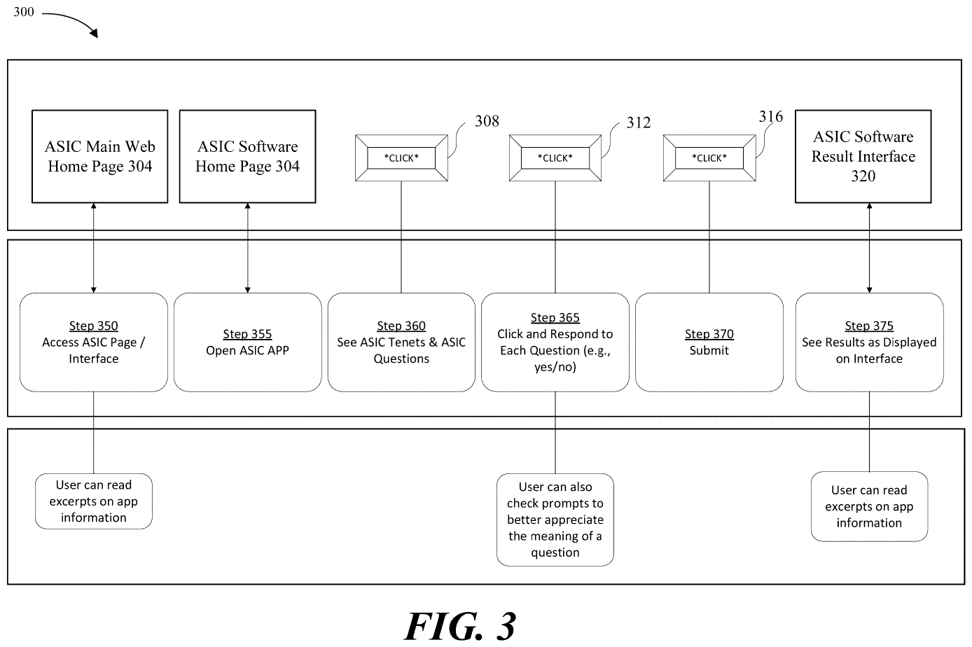

Referring now to FIG. 3, an exemplary usage flow of software 300 is shown. Software 300 may include displaying or interacting with a ASIC main web home page 304. ASIC main web home page 304 may be consistent with user interfaces as described throughout this disclosure. In some embodiments, process may include a step 350 of accessing the ASIC main web home page 304. In some embodiments, this may include a step 355 of opening an ASIC app (for example, on the web, on a computer, or on a smart phone). In some embodiments, on ASIC main web home page 304 user may read excerpts on application information.

With continued reference to FIG. 3, a user may perform a first click interaction 308. First click interaction 308 may trigger a step 360 of seeing ASIC tenants and ASIC questions. ASIC tenants may be consistent with the tenants described with reference to FIG. 1. ASIC questions may be consistent with plurality of queries 128 described with reference to FIG. 1.

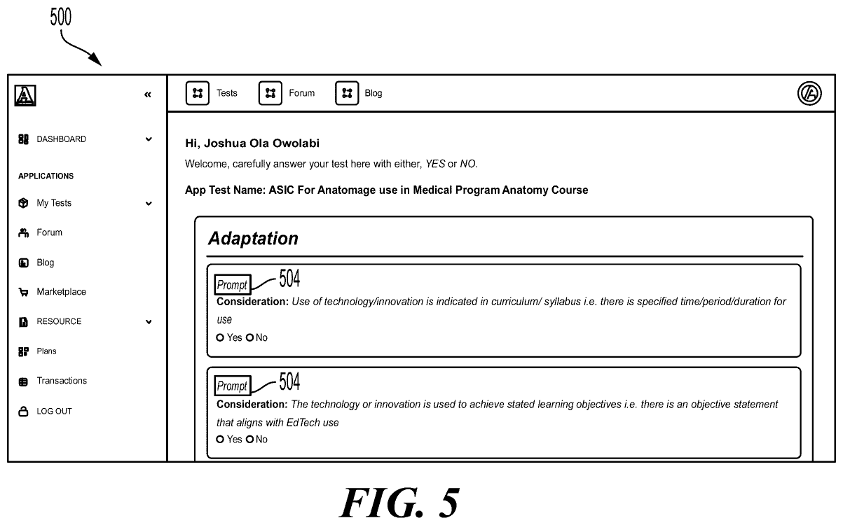

With continued reference to FIG. 3, user may perform a second click interaction 312 to perform a step 365 of clicking and responding to each questions. For example, this may include a binary response. In some embodiments, this may include clicking on a binary response element as described with reference to FIG. 1. In some embodiments, the user may check prompts to better appreciate the meaning of a question. For example, this may include interacting with a prompt button 504 as described further with reference to FIG. 5.

With continued reference to FIG. 3, user may perform a third click interaction 316 to trigger a step 370 of submitting the responses. This may include clicking or otherwise interacting with a submit button.

With continued reference to FIG. 3, ASIC software result interface 320 may be displayed to a user after responses are submitted. 320 may be consistent with aspects of exemplary user interface 200 as described with reference to FIG. 2. Step 375 may include seeing results displayed on the interface. In some embodiments, at this point, user may read excepts on application information.

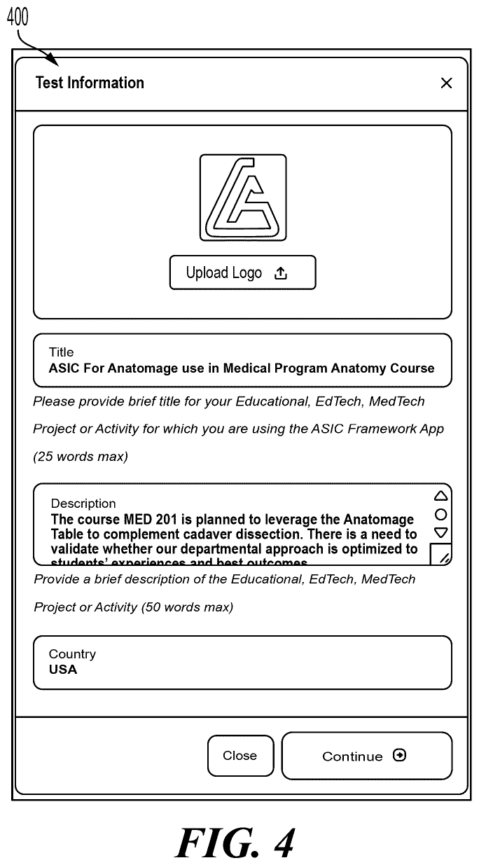

Referring now to FIG. 4, an exemplary input interface 400 is shown. In some embodiments, user may input candidate technology data 124 into exemplary input interface 400. For example, candidate technology data 124 may include a title, description, and/or a country. Exemplary input interface 400 may include a submit button. In some embodiments, exemplary input interface 400 may include a prompt to prompt user's entry of candidate technology data 124 for example, prompt, within the context of FIG. 4, may include “please provide brief title for your Educational EdTech, MedTech Project or Activity for which you are using the ASIC Framework APP.”

Referring now to FIG. 5, an exemplary response interface 500 is shown. Exemplary response interface 500 display queries to a user. Queries may be consistent with queries as described with reference to FIG. 1. In some embodiments, each of the plurality of queries may include a prompt button 504. In some embodiments, prompt button 504 may be configured to display a prompt when it is interacted with by a user. Prompt may be consistent with, e.g., prompts 144 described with reference to FIG. 1.

With continued reference to FIG. 5, prompt button 504 may include a prompt event handler. An “event handler,” for the purposes of this disclosure, is a component of software that is configured to detect the occurrence of an event and execute an action as a function of the detection of the event. In some embodiments, prompt event handler may be configured to detect a user interaction on prompt button 504. In some embodiments, user interaction on prompt button 504 may include clicking on it. In some embodiments, user interaction on prompt button 504 may include tapping on it. In some embodiments, user interaction on prompt button 504 may include hovering over it. As a function of detecting the user interaction, prompt event handler may be configured to display one or more prompts associated with the query.

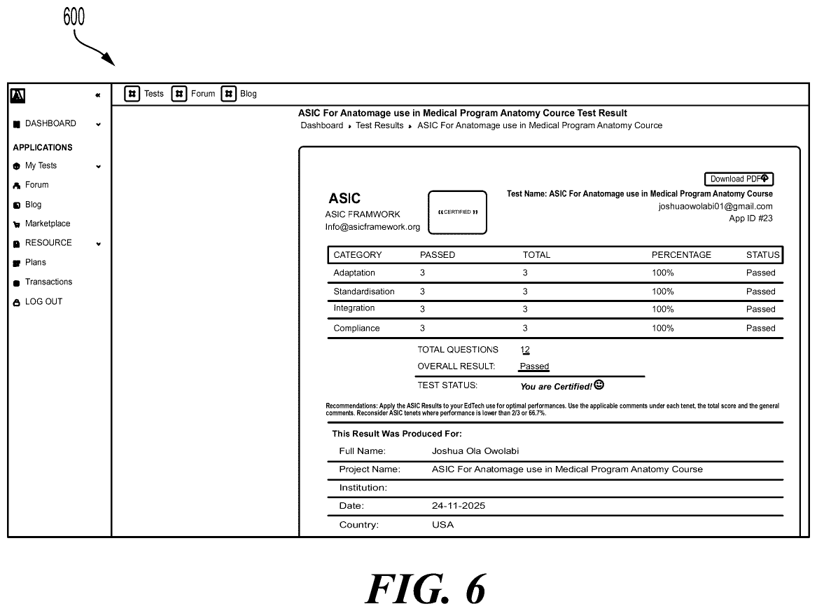

Referring now to FIG. 6, another exemplary user interface 600 is shown.

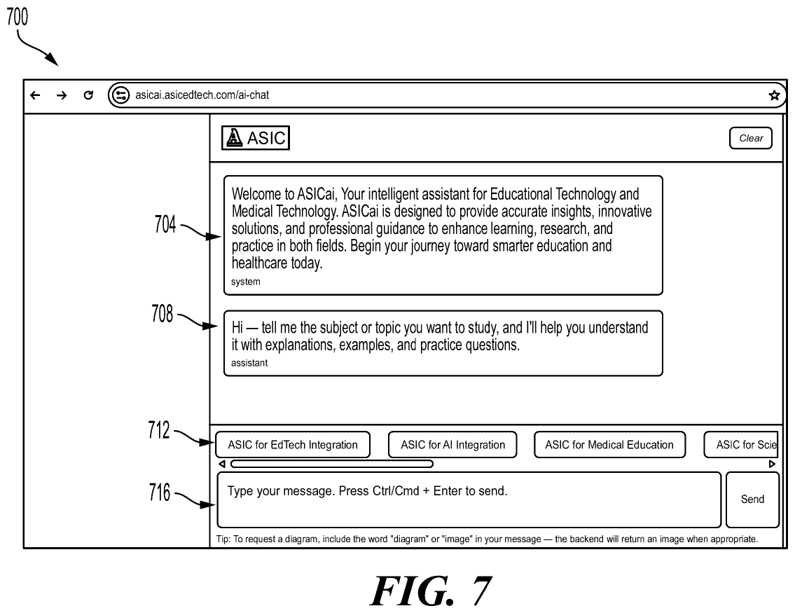

Referring now to FIG. 7, an exemplary chatbot interface 700 is shown. Exemplary chatbot interface 700 may include a chat interface wherein messages from the user and the chatbot may be displayed in a text messaging interface. Chatbot may be consistent with chatbot 160 as described with reference to FIG. 1. Exemplary chatbot interface 700 may include a greeting 704 for a user. Greeting 704 may include a standard greeting or a user-configured greeting. Exemplary chatbot interface 700 may include a user query 708. User query 708 may be consistent with user query 156 as described with reference to FIG. 1. Exemplary chatbot interface 700 may include mode selectors 712. User may interact with mode selectors 712 to determine what type of educational technology integration framework is being applied. This may be sent to the chatbot as additional context. Exemplary chatbot interface 700 may include a text box 716. Users may input user query 708 into 716//. Exemplary chatbot interface 700 may display chatbot response 164 below user query 708 within the chat interface so as to mimic a conversation.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular methods and systems used to implement the technology integration may be modified without changing the spirit of the invention, and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set fourth herein.

### EXAMPLES

### Example 1—Creation of a Digitized ASIC Framework

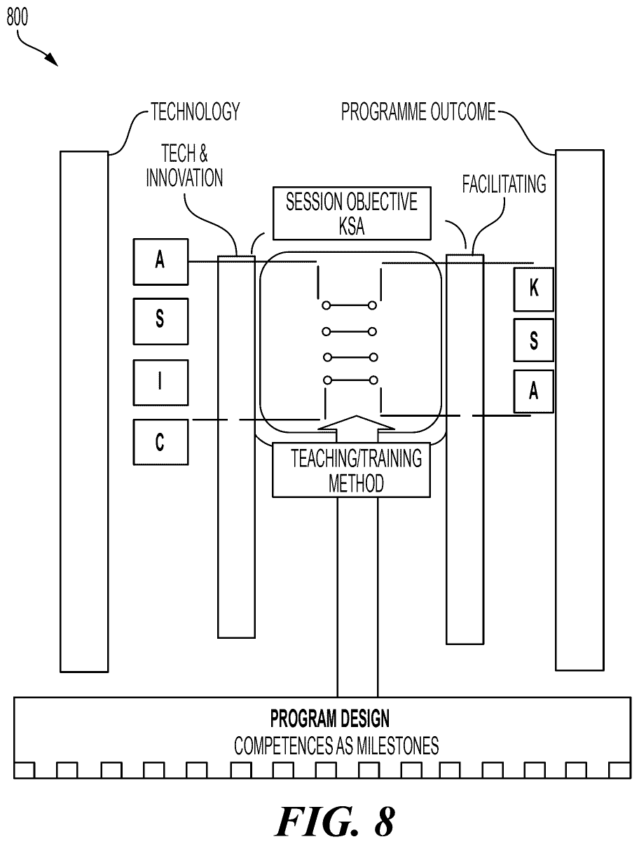

Referring now to FIG. 8, an exemplary embodiment 800 of an ASIC framework is shown. ASIC Framework adapted as from the original work on ASIC. Embodiment 800 shows a relationship between the use of technologies and innovations for educational purposes in a specified context such as the classroom or simulation facility in connection with the outcomes in the domains of knowledge skills and attitude. It also may represent the functional and operational relationship between technologies/innovations, teaching or training and program outcomes in relation to competencies as milestones based on program design.

With continued reference to FIG. 8, a multistep process for digitalizing the ASIC framework may be described with respect to FIG. 8. The process may start with defining a problem in need of a solution and continue to creating a product with proof of concepts for practical applications and navigating through technical and legal issues. While it is important to state that these steps were not necessarily followed strictly sequentially, it is important to note that the ten steps have been clearly highlighted in a way that they could form a practical guide for an educator or innovator seeking information on steps to a methodical approach or producing an educational innovation. They also serve to present evidence that the ASIC Framework has been developed with adequate considerations for the creative flow of thought, application of sound medical theories and principles and project management knowledge and skills.

With continued reference to FIG. 8, a step in the process may include defining a problem in need of intervention. The problem statement for the current work could be stated as follows: Heterogeneities in EdTech and Innovation use and impacts are resultant of a lack of established standard practices and poor adherence to pedogeological practices and relevant learning theories while deploying educational technology and innovations. The initial idea to have a framework, standard tool, guiding theory or a set of principles for optimizing the use of innovations and technologies for medical education was identified through experiences, multi-institutional, multinational, and action project activities. A critical appraisal of EdTech use in a medical school that was highly innovative and tech-driven yielded a number of considerations that were further crystalized into key tenets. A reflective practice and critical analysis of how the efforts succeeded helped to analyze the purpose of the key tenets. Further critical thinking and analysis helped to design a hypothetical educational ecosystem and connect the tenets with actual elements of the ecosystem, through an iterative process that helped design a sample reference framework model with working principles that could be applied to diverse educational systems. The four tenets may include Adaptation, Standardization, Integration and Compliance (i.e., ASIC). Consequently, the ASIC Framework operational matrix that addressed innovation and EdTech's optimization with emphasis on curriculum, pedagogy and assessment was designed. This ASIC Framework CPA Operational Matric was successfully digitized for ease of access, use and appraisal of educational innovations and technologies. It also accrues features that validate the use of the digital tool.

With continued reference to FIG. 8, a step in process may include establishing a sound theoretically correct and pedagogically sound model. For this step, it was important to ensure that the model aligned with relevant learning theories and pedagogical principles for teaching. Here are selected specific instances (See Table 4):

TABLE 4
Steps for Establishing a Sound Theoretically
Correct and Pedagogically Sound Model

| Key | |
|---|---|
| Considerations: | Additional Information: |
| Adult Learning | ASIC was designed with the premise that the beneficiaries |
| Theory | of EdTech use for medical and higher education are adults; it also |
| | considers a learner-centered approach. |
| Cognitive Load | ASIC design has a premise that EdTech use should |
| theory | minimize extraneous load and optimize intrinsic load, while |
| | managing germane load effectively. |
| Miller's pyramid | ASIC Framework allows that the learning outcomes should |
| | be clearly defined and measurable in line with the EdTech and |
| | innovation[s] used. |
| Kolb's Learning | The use of an Edtech is aligned with Kolb's cycle such that |
| Cycle | it could contribute to the process of achieving a holistic learning |
| | experience e.g. an educator could decide whether an EdTech |
| | served the purpose of experimentation or conceptualisation. |
| Bloom's Pyramid | There is a premise that the use EdTech or innovations |
| | should be aligned with an identified level of Bloom's pyramid. For |
| | example, an educator should determine whether learner who uses |
| | an interactive 3D anatomy digital atlas need to identify already |
| | dissected anatomic structures or to explore, self-dissect, identify |
| | and describe? |
| Visual, auditory, | Considerations for multiple modality nature of educational |
| reading/textual and | resources- There were considerations for the use of resources that |
| kinesthetics [VARK] | provide knowledge [cognitive], or that help to impart skills |
| modalities | [psychomotor] or attitude [affective] in the forms of visual, |
| | auditory, reading/textual and kinesthetics [VARK] modalities. |

With continued reference to FIG. 8, another step in this process may include generating practical evidence from practice. For example, after putting together ASIC as a framework, evidence was obtained from actual practice in different contexts of subjects, institutions and students.

With continued reference to FIG. 8, another step in this process may include designing an algorithm flow. An algorithm flow for the digital operation of ASIC was developed. An exemplary embodiments of an algorithm flow for the digital operation of ASIC may be shown and described with reference to FIG. 3.

With continued reference to FIG. 8, another step in this process may include writing codes and creating a suitable platform. In some embodiments, following the design of a suitable algorithm flow, specifications on cloud and web-based support platforms were considered and clearly defined with attributes such as the effectiveness of operations and functionality, user-friendly interface, user and app security, data protection, intractability, and access were key considerations. Following a proper understanding of the major considerations, the codes for the digital framework were written. A workflow for a test-analyze-validate-and-progress model was adopted.

With continued reference to FIG. 8, in some embodiments, an additional step in this process may include producing a proof of concept. In some embodiments, following the collection of coding and testing, ASIC was repeatedly tested. During this period of interaction, bugs were identified and fixed, and web aesthetics and interfacility were considered and addressed as well. Several modifications were made to ensure an optimally technically efficient ASIC product with quality attributes for access, security, reliability, interactivity and user-friendliness in terms of attractive interface aesthetics.

With continued reference to FIG. 8, another step in this process may include quality assurance and validation. For example, for the purpose of quality assurance: Multiple tests were run to test operations and output and to check for the product's efficiency.

With continued reference to FIG. 8, another step in this process may include reflective practice as tool of continuous refining of idea. In an embodiment, there has been regular analysis of feedback; much more importantly, a reflective practice based on experience, reflection and purposeful action [ERA] has been continually applied to ASIC to optimize the technical capacities of ASIC but also very importantly, the ease of use and applications to enhance user's productivity and efficiency in relevant contexts. This is an ever-continuous process.

With continued reference to FIG. 8, another step in this process may include product improvement through educational research. In some embodiments, there is a solid plan in place for Product Improvement through Educational Research. ASIC could be made available for educational research purposes and concession is made to researchers to afford them the opportunity to conduct research on product sustainability and impacts. Also, there may be a standard ASIC Research Instrument that can be used to conduct research, either by researchers in their immediate educational context which can be published eventually as educational research.

On the other hand, researchers can use the instrument to collect data as members of a global ASIC Edtech consortium towards advancing medical and higher education.

With continued reference to FIG. 8, another step in this process may include legal and technical conditions; continuous evaluation of product.

With continued reference to FIG. 8, the result of this multi-step process is the digitized ASIC framework. Digitized ASIC framework may be consistent with aspects of technology integration frameworks as described throughout this disclosure. The digital ASIC Framework may have aspects of the ASIC Framework, which emphasizes Adaptation, Standardization, Integration, and Compliance in three key areas, namely, Curriculum, Pedagogy and Assessment. While the ASIC tenets emphasize the key areas of consideration to address when deploying EdTech and innovations, the CPA emphasizes the core domains that require attention. The digital framework and its operational matrix allow the ASIC tenets to address the CPA domains in line with each tenet. For example, the operational matrix addresses the place of Adaptation in the place of curriculum, pedagogy and well as assessment. The digital framework may be provisioned as an App that requires the user to answer 12 questions in all with three-CPA (Curriculum, Pedagogy, Assessment) questions under each ASIC tenet.

With continued reference to FIG. 8, The Digital ASIC Framework may be accessed through the ASIC EdTech webpage or as an Android or IOS App. Once accessed or installed in the latter instance, the ASIC Digital interface may require the user to enter specific information about the EdTech of interest. A logo can also be provided. The interface thereafter requires the user to answer YES/NO to three questions CPA-[Curriculum-Pedagogy-Assessment] Questions under each ASIC-[Adaptation, Standardization, Integration, and Compliance] tenet. Upon completion and submission, the result is generated with unique features for identity including the ASIC scores, the performance indicators both in numerical values as percentages and in graphical format. The total sum of impact value is also provided. The result is released with a barcode feature that can always be used to access the results and verify their authenticity The result is also archived under the user's account and it is perpetually accessible. When downloading the unique result, the ASIC interpretation rubric is also downloadable for reference.

With continued reference to FIG. 8, ASIC Framework may include four tenets namely Adaptation, Standardization, Integration, and Compliance. In terms of working principles, the ASIC operational matric may considers the application of the four tenets to three core areas of an educational experience namely: curriculum, pedagogy and assessment. This is important as the inability to operationalize the ASIC Framework would either create ambiguity and subjectivity or make it impractical for accurate application. Application of ASIC to curriculum helps to address the validity and reliability of the use of EdTech and innovation for an educational experience. It also helps to determine whether the EdTech and innovation as used could provide an appropriate and adequate educational experience based on curricular requirements and whether a plan for consistent and accurate repeatability has been considered. Pedagogy also helps with the validity of an educational experience by assuring educational methods in line with relevant theories and principles such as adult learning theories. Assessment helps to measure the impact value of an EdTech/innovation on learning experience as a measure of performance.

An educational Ecosystem may be described as a system of structural and functional domains or systems interconnected by an operational network and governed by established principles and rules towards achieving an educational outcome. In a typical educational ecosystem, the structural components include physical infrastructures and the hardware that help facilitate educational experiences. This might include the physical learning spaces such as classes, laboratories, and simulation rooms; others might include machines and hardware such as computer devices, media, and specific-purpose machines such as the MRI machine in the hospital, microscopes in the laboratory and high-fidelity mannequins in the simulation laboratories. The functional components of the ecosystem include activities that enable the use of these infrastructures and resources for facilitating sessions in classrooms, clinics, laboratories, workshops or open fields and other contexts of training or practice. With technologies and innovations, the networks that interconnect the structural and functional aspects of the ecosystems could be facilitated by the internet connection, or actual structural and electrical connections, aided or operated by humans or other machines. In the educational ecosystem, humans are their ultimate operators and activities are guided and aided by theories, rules, principles, and standard practices often provided as policies and guidelines.

To operationalize ASIC in an educational ecosystem, the culture of the system is of key importance. Innovations and technologies could significantly shape the culture of an educational system. It is important to carefully assess the current prevalent culture, and define the desired change to the current culture as well as the process for leading the desired change with innovations and technologies playing key roles. This is why the 4Ps become of key consideration. While ASIC could help individual members of the educational system to develop and optimize technologies and innovation, the entire organization could also use ASIC for leading change with innovations in accordance with the steps indicated for ASIC For Institutional and Professional Use as indicated in the previous section.

Significance of the Digitized ASIC Framework CPA Operational Matrix: The rapid nature of educational changes as driven by technology and innovations, coupled with a lack of requisite knowledge of educational principles that apply to EdTech and innovations coupled with a lack of practical skills to apply them has created significant heterogeneities in methods, manners and strategies for leading change with innovations as well as skillful and effective deployment of EdTech and innovations for optimal educational experiences. Heterogeneity, therefore, has emerged as a major problem with Edtech for educational activities. There are clear cases of heterogeneities in the types of EdTech that are available for similar educational purposes i.e. validating the vast number of options to choose from when seeking to use Tech and innovations for educational purposes. Interestingly, the eventual choices are not often premised on empirical evidence or educational values or based on guiding principles but on sentiments that bother on expert opinions, availability of funds and institutional agenda. Where existing theories and principles can be applied to guide Edtech use, many experts lack the requisite knowledge of such fundamentals or the skills and capacity to apply them in their judgements of choice and methods of use. Another source of heterogeneities is the indiscriminate use of technologies to achieve pedagogical activities that are somewhat traditional or well established without recourse to the use of evidence and application of principles to ensure the validity and reliably of the innovations or Edtech to achieve similar or better outcomes with the EdTech or innovations relative to the established principles. Often, short-term gains and immediate but arguably unsustainable results are considered as the main sources of motivation.

The ASIC framework was initially developed and has four key tenets, namely: Adaptation, Standardization, Integration, and Compliance. These key tenets were organized into a functional framework, from which an algorithm was developed to optimize it for determining the validity and reliability of an educational innovation or technology to optimally provide an educational experience with emphasis on the curriculum, pedagogy and assessment. This algorithm has been effectively digitalized.

The fact that several types of technologies and innovations can be suitably adapted and integrated into a medical or health education program using the ASIC Framework is important. ASIC can guide strategic advancements with technologies and innovations in medical education with diverse products including Artificial Intelligence, noting that the value of AI in medical education and care is now being seriously explored.

The Problem of Heterogeneities in Relation to EdTech and Innovations for Medical and ASIC-derived Solutions: There is no doubt that with the increase in advancements in technology and innovation, there will be several new types of innovations or technologies that can be used for medical education and, by extension, higher education in general. The implication of this is that there will be more varieties of tech innovations from which educators are required to choose. With more choices available, the reality of using a wide range of innovative approaches and technologies for similar purposes in different contexts of medical education will also come to light. An abundance of choice in terms of the available innovations or tech might not be a problem in itself, but heterogeneity would definitely result if standards are not set with clear guiding principles. Understandably, not all educators have extensive expertise in the primary domains of medical education in addition to their scientific and clinical competencies. The implication of this reality is that the requisite knowledge and competence to make informed decisions about the most appropriate technology and innovations in relation to pedagogical framework to use would vary from place to place.

This is therefore why a case is being made for the use of a tested and standardized framework such as the ASIC. Not only is this framework premised on clearly stated educational theories and pedagogical principles, it also has the versatility that supports its deployment in almost any context of medical education. It is also not cumbersome for educators to understand, especially in terms of its operational principles and applications. Clearly, digitizing this framework is also a way to democratize it and make it readily available to people in almost any part of the world. This is arguably one of the most educational frameworks with clearly listed pedagogical principles of the 21st century that addresses the use of innovation and technologies for medical education.

It is important to state that, unlike several other existing pedagogical frameworks that use descriptive attributes and guiding principles, the ASIC also has a quantitative approach to its use, measure of impact, and interpretation of the same. It is clearly a modern pedagogical framework that ranks favorably in terms of application with other popularly used pedagogical frameworks such as the Kolb's learning cycle, the Argyris and Schon's loops, a Bloom's taxonomy, and Miller's pyramid. Nevertheless, credit should be given to the proponents of all relevant existing theories of learning and pedagogical frameworks, since they form the basis of scientific evidence to support the application and validity of the ASIC framework. It is highly recommended for individual educators, irrespective of their level of proficiency and experience, as it can objectively and consistently guide the decision-making processes regarding which type of educational technology and innovations to adopt, and more importantly, how to use such innovations or tech consistently and in line with learning theories and pedagogical principles. It is equally highly recommended to institutions and communities of practice. ASIC is arguably the only tool available currently to institutions and communities of practice to collaboratively make decisions on the best and most appropriate type of innovations and EdTech to adopt, and to justify the implementation plan by considering the four key tenets of adaptation, standardization, integration, and compliance. Furthermore, it emphasizes all the primary domains of learning, which include cognitive, psychomotor, and affective.

Also, it is important to further highlight that the problem of heterogeneity is not just about the diverse types of educational innovations and technologies that are available, but also the variations that exist in how they are used for similar purposes in different places and at different times. This aspect of heterogeneity regarding the use of edtech and innovations can impact the qualities of validity and reliability, which are key attributes that define the assessment of learning and consequently provide justification for the acquisition of competencies. When an assessment cannot be adjudged to be valid and reliable following the use of technology and innovations, not just at the level of individual sessions or institutions but across professional settings, there arises a very important need to ensure that technologies and innovations are used in alignment with curriculum requirements, in line with sound learning theories and pedagogical principles, and validly and reliably in line with assessment principles.

Therefore, in addition to guiding pedagogical approaches to using innovation and edtech, ASIC also provides the basis for establishing the reliability and validity of assessments. Very importantly, this is done with a big picture of the entire program and its desired outcomes often defined by stated competencies.

Promoting a Culture of Best-Practice: One of the realities that has emerged as a result of gaps in the resources available to different institutions in various places is the significant potential gap in what constitutes standard practices across institutions that claim to train medical and health professionals. These professionals are expected to acquire similar levels of competencies at the end of their training. If the inequity that the disproportionate availability of resources to different institutions creates takes medical education back to a scenario similar to what existed prior to Flexner's reform of the early 1900s, the quality of medical education could vary significantly across institutions because there were no regulations that set the standard for best practices.

It is therefore important to say that the ASIC Framework, as an instrument, has significant value to contribute to promoting the culture of best practices in medical education and related communities of practice. It is also important to state that other existing pedagogical frameworks that have been listed or mentioned in this article were created at a certain point in time by competent educators, and they were continually applied and oftentimes refined to support educational activities. It would appear that the development of the ASIC framework also has a place in the timeline of the history of education as a tool that could address the current trend characterized by significant adoption and use of innovations and technologies for medical and higher education.

Using ASIC to Counter Neo-Luddism: The Luddite movement was responsible for a major campaign against the introduction of technology into the textile industry in Europe. From this event, attempts to resist the introduction of technology into a particular domain in the years that followed this historical event have been dubbed “Neo-Luddism”. The problem of Neo-Luddism has often been touted as opposition to the use of technology for medical education in certain instances, and the actors involved are often dubbed Neo-Luddites or anti-technology people [41-44]. However, it is important to highlight that oftentimes people who resist technology or who are rather indifferent but unimpressed at the same time are often cautious about the negatively disruptive tendencies of certain technologies or poorly integrated innovative approaches. Even in the context of E-Health, three groups of non-adopters of e-health technology have been identified as postponers, opponents and critics, with the postponers and opponents groups including patients and families of patients. Instances of failed attempts to deploy technology for educational purposes have reinforced resistant behavior in certain instances.

It is therefore important to understand that the use of evidence and a pedagogical framework to promote the use of technology, with an effort to not just promote standard practices but to continuously evaluate the performance of innovations and technology, could help address Neo-Luddism and provide convincing evidence to Neo-Luddites tech-ethicists. Tech-ethicists are a group of people who would insist that technologies are not used to break existing rules or disrupt existing orders in education. Noting that the introduction and integration of major technologies or innovations in an aspect of education could have a ripple effect, the use of a pedagogical framework can help to properly analyze the prospect and potential effects and to ensure that they are positive in terms of the impact that they might make in other aspects or domains of medical education. This argument, as presented here, is another strong indication why the ASIC Framework could be very significant to the advancement of modern medical education and should be given serious consideration by medical educators and other stakeholders, including academic leaders. People's appreciation for use of technologies in medicine currently varies significantly; with better education, exposure and promotion of best-practices educators, professional and patients will increasingly appreciate the value of technologies.

Importance of ASIC to Stakeholders-Educators, Administrators, Instructional Designers, and Academic Leaders: Much of the case that has been made for a need to standardize the use of EdTech and innovation has emphasized the importance of a standard framework for the job of medical educators.

Administrators can also be better guided on making decisions on the choice of technologies to procure and in developing a plan to integrate technologies and innovation into the educational ecosystem, while assuring value for the investment of resources and capital. For instructional designers, it is important for them to consider the specific innovation or technology that is being introduced and the impact of the same on the existing educational and infrastructure ecosystem. For example, it might be important to consider how a new technology, such as an educational software, might be integrated into the existing learning management system with optimized access provided to the student. It might also be important to consider how other resources that are already in existence will be functionally connected with a newly introduced technology or innovation such that they can run in sync for an optimal student experience. More than ever before, instructional designers have to consider not just the prospect of a particular edtech or innovation based on its performance, but also its synchronization with other components of the educational ecosystem.

Academic leaders are often required to ultimately make decisions regarding the innovations and technologies to be procured for their various programs or groups of students. There are times when they are required to consider cases or even arguments as presented by educators and other stakeholders. Using a framework such as the ASIC can guide all these stakeholders in working collaboratively to arrive at the best possible decisions by aligning paradigms, while at the same time considering the value of technologies and innovations on the basis of their potential educational value or impact. For example, it is possible that a newly developed sophisticated technology might not be adding significant value to the program on the basis of competencies that are required of students, even when the proponents are quite enthusiastic about its futuristic value. A practical framework can therefore help an academic leader to judge innovation and technology on the basis of its value for money and return on investment, in addition to the actual educational value. Should there be an instance where an institution chooses to be a trailblazer by pushing the boundary of training by considering the use of a particular technology or innovation that is not already aligned with stated competencies to be acquired through a program, a standard framework such as the ASIC might still be able to help in carefully measuring what is to be committed to such effort while ensuring that it is not done at the expense of the already established and identified outcomes, which might be used by regulators and institutional standards to judge the success of the program. Academic leader, especially, should also be aware that a major ay to capitalize on the value of that Edtech and innovation could add to the future of medical education is to start enshrining a health culture of technology into medical education right from now. Future doctors and health worker would practice in a tech-enriched environment that they need to be exposed adequately to technology during their training.

### Example 2—Implementation of ASIC for Individuals

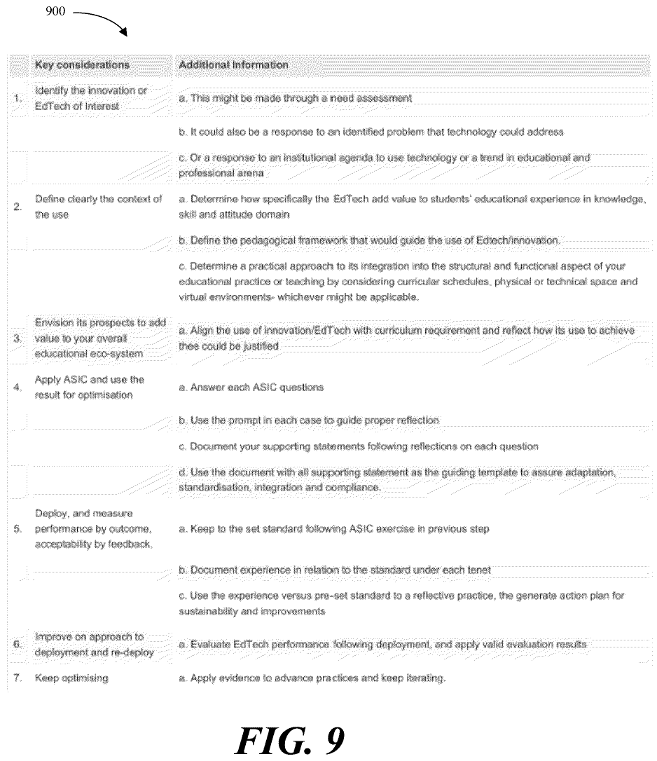

Now referring to FIG. 9, some key considerations 900 for individuals when using ASIC are shown. When used by an individual educator, ASIC could help to make the choice of the most appropriate innovation or EdTech to acquire, how to systematically integrate the EdTech/innovation into a course or program and how to optimize the use of the EdTech, then validly and reliably measure the impact through assessments of students and evaluation of the experience.

### Example 3—Implementation of ASIC for Groups

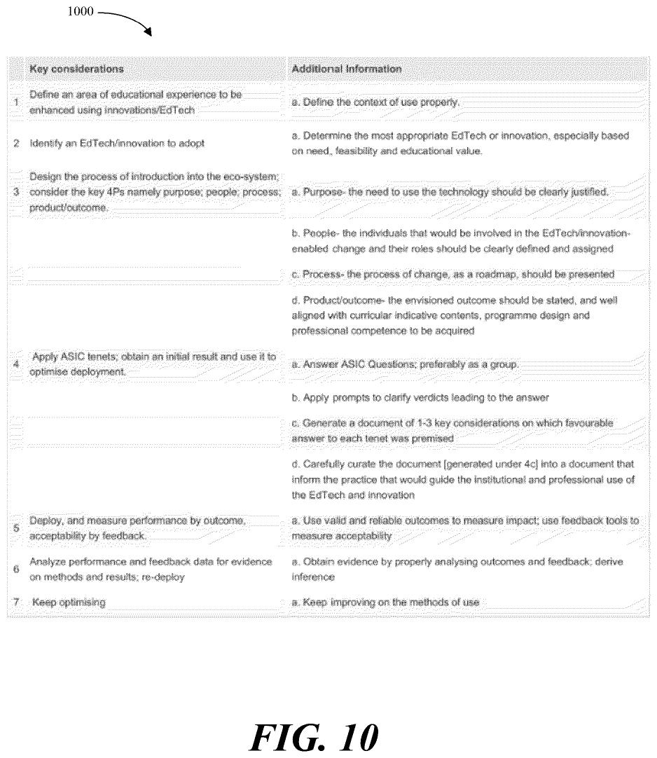

Now referring to FIG. 10, some key considerations 1000 for group use when using ASIC are shown. A group of faculty members such a member of a department or faculty members in a program can collaboratively use ASIC to guide EdTech deployment, and to measure impacts and plan further improvement. In this instance, each faculty member or stakeholders can complete the ASIC Instrument, then averages of responses are computed and the interpretations of the verdicts based on the ASIC rubrics. The alternative approach would be that the group of educators deliberate and arrive at a consensus on each ASIC Instrument item. Then, the consensus is interpreted using the rubric and this final outcome being reflections of collective verdict would guide decisions on EdTech use and optimization. The benefit of the latter approach is that the ASIC Instrument can be used iteratively. When an ASIC tenet scores zero, deliberations can help to reflect on the existing circumstances, and a decision can be made to restructured the same to favor a positive consideration such that the process help to also determine the change that are required to favor the use of the EdTech/innovation of interest.

### Example 4—Implementation of ASIC for Institutions and Professional Bodies

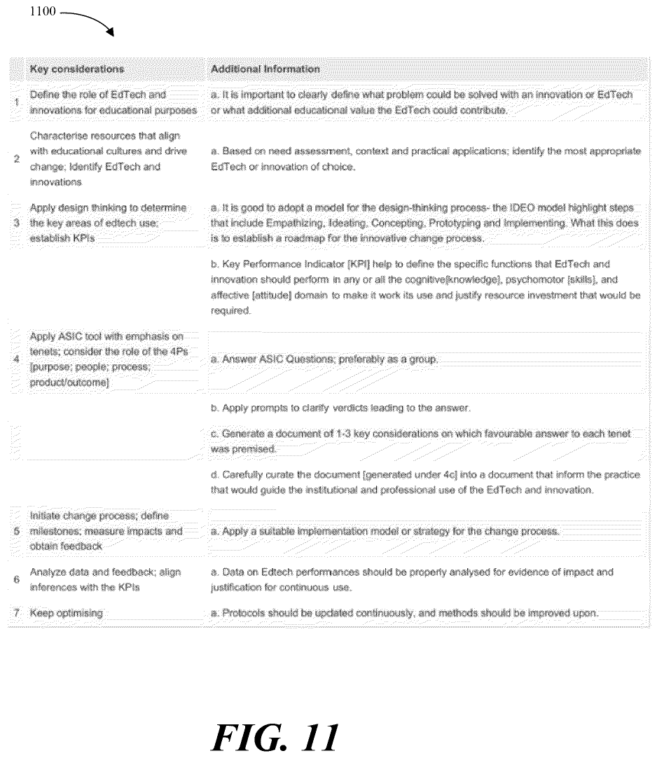

Referring now to FIG. 11, some key considerations 1100 for institutional and professional use when using ASIC are shown. In the professional circle, such as the community of practice, ASIC can help to come up with standard practices or recommendation regarding use of an innovation or EdTech especially when such is new or when an existing EdTech or innovation is being adapted or repurposed. ASIC could help in determining the educational value of such EdTech/innovation and their potential impact. Since the exercise in this instance would normally include a group of experts, the reflective processes that lead to answering ASIC question and coming up with positive answer would equally lead generating statements of guidelines on standard practice.

### Methods

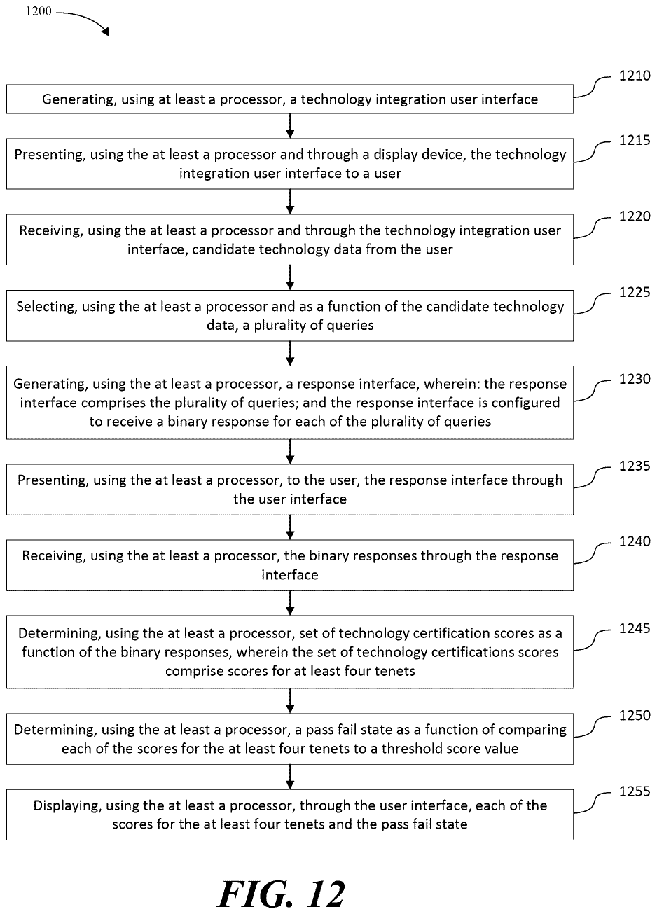

Referring now to FIG. 12, a method 1200 for generation of a user interface for technology integration is shown. 1200 may include a step 1210 of generating, using at least a processor, a technology integration user interface. In some embodiments, this may be implemented, without limitation, as described with reference to FIGS. 1-13.

With continued reference to FIG. 12, method 1200 may include a step 1215 of presenting, using the at least a processor and through a display device, the technology integration user interface to a user. In some embodiments, this may be implemented, without limitation, as described with reference to FIGS. 1-13.

With continued reference to FIG. 12, method 1200 may include a step 1220 of receiving, using the at least a processor and through the technology integration user interface, candidate technology data from the user. In some embodiments, this may be implemented, without limitation, as described with reference to FIGS. 1-13.

With continued reference to FIG. 12, method 1200 may include a step 1225 of selecting, using the at least a processor and as a function of the candidate technology data, a plurality of queries. In some embodiments, this may be implemented, without limitation, as described with reference to FIGS. 1-13.

With continued reference to FIG. 12, method 1200 may include a step 1230 of generating, using the at least a processor, a response interface, wherein: the response interface includes the plurality of queries; and the response interface is configured to receive a binary response for each of the plurality of queries. In some embodiments, this may be implemented, without limitation, as described with reference to FIGS. 1-13.

With continued reference to FIG. 12, method 1200 may include a step 1235 of presenting, using the at least a processor, to the user, the response interface through the user interface. In some embodiments, this may be implemented, without limitation, as described with reference to FIGS. 1-13.

With continued reference to FIG. 12, method 1200 may include a step 1240 of receiving, using the at least a processor, the binary responses through the response interface. In some embodiments, this may be implemented, without limitation, as described with reference to FIGS. 1-13.

With continued reference to FIG. 12, method 1200 may include a step 1245 of determining, using the at least a processor, set of technology certification scores as a function of the binary responses, wherein the set of technology certifications scores include scores for at least four tenets. In some embodiments, this may be implemented, without limitation, as described with reference to FIGS. 1-13.

With continued reference to FIG. 12, method 1200 may include a step 1250 of determining, using the at least a processor, a pass fail state as a function of comparing each of the scores for the at least four tenets to a threshold score value. In some embodiments, this may be implemented, without limitation, as described with reference to FIGS. 1-13.

With continued reference to FIG. 12, method 1200 may include a step 1255 of displaying, using the at least a processor, through the user interface, each of the scores for the at least four tenets and the pass fail state. In some embodiments, this may be implemented, without limitation, as described with reference to FIGS. 1-13.

In some aspects, the techniques described herein relate to a method, wherein displaying, through the user interface, each of the scores for the at least four tenets includes displaying through the user interface, a circumferential meter, wherein the circumferential meter is configured to display a circumferential segment each of the scores for the at least four tenets as spanning a segment of a circumference of a circle, wherein the length of the circumferential segment is determined by a ratio of each of the scores of the at least four tenets to a maximum value. In some embodiments, this may be implemented, without limitation, as described with reference to FIGS. 1-13.

In some aspects, the techniques described herein relate to a method, wherein the circumferential meter includes: a first circumferential segment associated with a first tenet; a second circumferential segment associated with a second tenet; a third circumferential segment associated with a third tenet; and a fourth circumferential segment associated with the fourth tenet; and wherein the first circumferential segment, the second circumferential segment, the third circumferential segment, and the fourth circumferential segment are concentrically located on the circumferential meter. In some embodiments, this may be implemented, without limitation, as described with reference to FIGS. 1-13.

In some aspects, the techniques described herein relate to a method, wherein the at least four tenets include adaptation, standardization, integration, and compliance. In some embodiments, this may be implemented, without limitation, as described with reference to FIGS. 1-13.

In some aspects, the techniques described herein relate to a method, wherein the plurality of queries includes at least three queries for each of the four tenets. In some embodiments, this may be implemented, without limitation, as described with reference to FIGS. 1-13.

In some aspects, the techniques described herein relate to a method, wherein determining the set of technology certification scores includes determining scores for the at least four tenets, wherein determining the scores for the at least four tenets includes: assigning a binary value as a function of the binary response to each of the plurality of queries; and averaging the binary values for a tenet of the at least four tenets. In some embodiments, this may be implemented, without limitation, as described with reference to FIGS. 1-13.

In some aspects, the techniques described herein relate to a method, further including: receiving, using the at least a processor and through a user interface, a user query, wherein the user query includes at least a string of natural language text related to technology integration; generate, using the at least a processor and a technology integration large language model (LLM), a chatbot response as a function of the user query; and present, using the at least a processor and through the user interface, the chatbot response.

In some embodiments, this may be implemented, without limitation, as described with reference to FIGS. 1-13.

### Computing Device

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

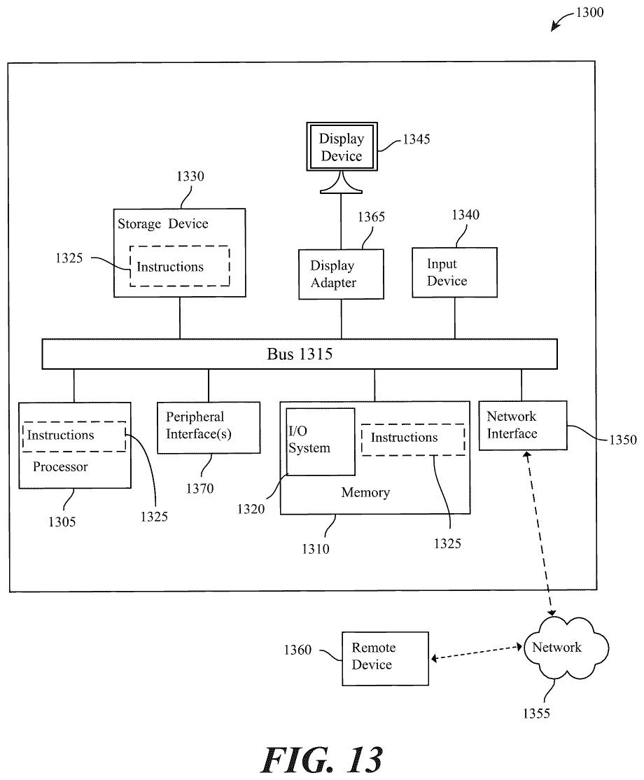

FIG. 13 shows a diagrammatic representation of one embodiment of a computing device in the exemplary form of a computer system 1300 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1300 includes a processor 1305 and a memory 1310 that communicate with each other, and with other components, via a bus 1315. Bus 1315 may include any of several types of bus structures including, but not limited to, a memory bus, a memory controller, a peripheral bus, a local bus, and any combinations thereof, using any of a variety of bus architectures.

Processor 1305 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1305 may be organized according to Von Neumann and/or Harvard architecture as a non-limiting example. Processor 1305 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 1310 may include various components (e.g., machine-readable media) including, but not limited to, a random-access memory component, a read only component, and any combinations thereof. In one example, a basic input/output system 1320 (BIOS), including basic routines that help to transfer information between elements within computer system 1300, such as during start-up, may be stored in memory 1310. Memory 1310 may also include (e.g., stored on one or more machine-readable media) instructions (e.g., software) 1325 embodying any one or more of the aspects and/or methodologies of the present disclosure. In another example, memory 1310 may further include any number of program modules including, but not limited to, an operating system, one or more application programs, other program modules, program data, and any combinations thereof. Memory 1310 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 1300 may also include a storage device 1330. Examples of a storage device (e.g., storage device 1330) include, but are not limited to, a hard disk drive, a magnetic disk drive, an optical disc drive in combination with an optical medium, a solid-state memory device, and any combinations thereof. Storage device 1330 may be connected to bus 1315 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1330 (or one or more components thereof) may be removably interfaced with computer system 1300 (e.g., via an external port connector (not shown)). Particularly, storage device 1330 and an associated machine-readable medium may provide nonvolatile and/or volatile storage of machine-readable instructions, data structures, program modules, and/or other data for computer system 1300. In some embodiments, storage device 1330 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 1325) may reside, completely or partially, within machine-readable medium. In another example, software may reside, completely or partially, within processor 1305.

Computer system 1300 may also include an input device 1340. In one example, a user of computer system 1300 may enter commands and/or other information into computer system 1300 via input device 1340. Examples of an input device 1340 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1340 may be interfaced to bus 1315 via any of a variety of interfaces (not shown) including, but not limited to, a serial interface, a parallel interface, a game port, a USB interface, a FIREWIRE interface, a direct interface to bus 1315, and any combinations thereof. Input device 1340 may include a touch screen interface that may be a part of or separate from display 1345, discussed further below. Input device 1340 may be utilized as a user selection device for selecting one or more graphical representations in a graphical interface as described above.

A user may also input commands and/or other information to computer system 1300 via storage device 1330 (e.g., a removable disk drive, a flash drive, etc.) and/or network interface device 1350. A network interface device, such as network interface device 1350, may be utilized for connecting computer system 1300 to one or more of a variety of networks, such as network 1355, and one or more remote devices 1360 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1355, may employ a wired and/or a wireless mode of communication. In general, any network topology may be used. Information (e.g., data, software, etc.) may be communicated to and/or from computer system 1300 via network interface device 1350.

Computer system 1300 may further include a video display adapter 1365 for communicating a displayable image to a display device, such as display 1345. Examples of a display device include, but are not limited to, a liquid crystal display (LCD), a cathode ray tube (CRT), a plasma display, a light emitting diode (LED) display, and any combinations thereof. Display adapter 1365 and display 1345 may be utilized in combination with processor 1305 to provide graphical representations of aspects of the present disclosure. In addition to a display device, computer system 1300 may include one or more other peripheral output devices including, but not limited to, an audio speaker, a printer, and any combinations thereof. Such peripheral output devices may be connected to bus 1315 via a peripheral interface 1370. Examples of a peripheral interface include, but are not limited to, a serial port, a USB connection, a FIREWIRE connection, a parallel connection, and any combinations thereof.

Further referring to FIG. 13, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 13, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 13, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 1300, processor 1305, and memory 1310 may be virtualized; that is, a virtual machine and/or container may interact directly with such computing system 1300, processor 1305, and/or memory 1310, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 1305 comprises a plurality of processors and/or processor cores, virtualization may, in some cases, simulate or emulate a single (virtual) processor whose functions are allocated to one or more of the plurality of processors and/or processor cores. In this case, while processor 1305 may be said to be virtualized, the processor 1305, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. An apparatus for generation of a user interface for technology integration, the apparatus comprising:
at least a processor; and
a memory, the memory communicatively connected to the at least a processor, wherein the memory contains instructions configuring the at least a processor to:
generate a technology integration user interface;
present, through a display device, the technology integration user interface to a user;
receive, through the technology integration user interface, candidate technology data from the user;
select, as a function of the candidate technology data, a plurality of queries;
generate a response interface, wherein:
the response interface comprises the plurality of queries; and
the response interface is configured to receive a binary response for each of the plurality of queries;
present, to the user, the response interface through the user interface;
receive the binary responses through the response interface; and
determine a set of technology certification scores as a function of the binary responses, wherein the set of technology certifications scores comprise scores for at least four tenets;
determine a pass fail state as a function of comparing each of the scores for the at least four tenets to a threshold score value; and
display, through the user interface, each of the scores for the at least four tenets and the pass fail state.

2. The apparatus of claim 1, wherein displaying, through the user interface, each of the scores for the at least four tenets comprises displaying through the user interface, a circumferential meter, wherein the circumferential meter is configured to display a circumferential segment each of the scores for the at least four tenets as spanning a segment of a circumference of a circle, wherein a length of the circumferential segment is determined by a ratio of each of the scores of the at least four tenets to a maximum value.

3. The apparatus of claim 2, wherein the circumferential meter comprises:
a first circumferential segment associated with a first tenet;
a second circumferential segment associated with a second tenet;
a third circumferential segment associated with a third tenet; and
a fourth circumferential segment associated with the fourth tenet.

4. The apparatus of claim 3, wherein the first circumferential segment, the second circumferential segment, the third circumferential segment, and the fourth circumferential segment are concentrically located on the circumferential meter.

5. The apparatus of claim 1, wherein the at least four tenets comprise adaptation, standardization, integration, and compliance.

6. The apparatus of claim 1, wherein the plurality of queries comprises at least three queries for each of the four tenets.

7. The apparatus of claim 1, wherein determining the set of technology certification scores comprises determining scores for the at least four tenets, wherein determining the scores for the at least four tenets comprises assigning a binary value as a function of the binary response to each of the plurality of queries.

8. The apparatus of claim 7, wherein determining the scores for the at least four tenets comprises averaging the binary values for a tenet of the at least four tenets.

9. The apparatus of claim 1, wherein the memory contains instructions further configuring the at least a processor to display, with each of the scores for the at least four tenets and the pass fail state, a barcode, wherein the barcode comprises a quick-response (QR) code.

10. The apparatus of claim 1, wherein selecting the plurality of queries comprises selecting, for one or more of the plurality of queries, one or more prompts, wherein the one or more prompts are configured to provide guidance to the user on answering the plurality of queries.

11. The apparatus of claim 10, wherein each of the plurality of queries comprises a prompt button comprising a prompt event handler, wherein the prompt event handler is configured to:
detect a user interaction on the prompt button; and
in response to detecting the user interaction, display the one or more prompts associated with that query.

12. The apparatus of claim 1, wherein the memory contains instructions further configuring the at least a processor to:
receive, through a user interface, a user query, wherein the user query comprises at least a string of natural language text related to technology integration;
generate, using a technology integration large language model (LLM), a chatbot response as a function of the user query; and
present, through the user interface, the chatbot response.

13. An method for generation of a user interface for technology integration, the method comprising:
generating, using at least a processor, a technology integration user interface;
presenting, using the at least a processor and through a display device, the technology integration user interface to a user;
receiving, using the at least a processor and through the technology integration user interface, candidate technology data from the user;
selecting, using the at least a processor and as a function of the candidate technology data, a plurality of queries;
generating, using the at least a processor, a response interface, wherein:
the response interface comprises the plurality of queries; and
the response interface is configured to receive a binary response for each of the plurality of queries;
presenting, using the at least a processor, to the user, the response interface through the user interface;
receiving, using the at least a processor, the binary responses through the response interface; and
determining, using the at least a processor, set of technology certification scores as a function of the binary responses, wherein the set of technology certifications scores comprise scores for at least four tenets;
determining, using the at least a processor, a pass fail state as a function of comparing each of the scores for the at least four tenets to a threshold score value; and
displaying, using the at least a processor, through the user interface, each of the scores for the at least four tenets and the pass fail state.

14. The method of claim 13, wherein displaying, through the user interface, each of the scores for the at least four tenets comprises displaying through the user interface, a circumferential meter, wherein the circumferential meter is configured to display a circumferential segment each of the scores for the at least four tenets as spanning a segment of a circumference of a circle, wherein a length of the circumferential segment is determined by a ratio of each of the scores of the at least four tenets to a maximum value.

15. The method of claim 14, wherein the circumferential meter comprises:
a first circumferential segment associated with a first tenet;
a second circumferential segment associated with a second tenet;
a third circumferential segment associated with a third tenet; and
a fourth circumferential segment associated with the fourth tenet.

16. The method of claim 15, wherein the first circumferential segment, the second circumferential segment, the third circumferential segment, and the fourth circumferential segment are concentrically located on the circumferential meter.

17. The method of claim 13, wherein the at least four tenets comprise adaptation, standardization, integration, and compliance.

18. The method of claim 13, wherein the plurality of queries comprises at least three queries for each of the four tenets.

19. The method of claim 13, wherein determining the set of technology certification scores comprises determining scores for the at least four tenets, wherein determining the scores for the at least four tenets comprises:
assigning a binary value as a function of the binary response to each of the plurality of queries; and
averaging the binary values for a tenet of the at least four tenets.

20. The method of claim 13, further comprising:
receiving, using the at least a processor and through a user interface, a user query, wherein the user query comprises at least a string of natural language text related to technology integration;
generate, using the at least a processor and a technology integration large language model (LLM), a chatbot response as a function of the user query; and
present, using the at least a processor and through the user interface, the chatbot response.
